(19) United States
(12) Patent Application Publication
(10) Pub. No.: US 2010/0251375 A1
(43) Pub. Date: Sep. 30, 2010

(54) METHOD AND APPARATUS FOR MINIMIZING NETWORK VULNERABILITY

(75) Inventors: Paul Green, Annapolis, MD (US); Travis Goodspeed, Philadelphia, PA (US); Riley Porter, Silver Spring, MD (US)

Correspondence Address: CARTER, DELUCA, FARRELL & SCHMIDT, LLP, 445 BROAD HOLLOW ROAD, SUITE 420, MELVILLE, NY, 11747, US

(73) Assignee: G2, INC., Columbia, MD (US)

(21) Appl. No.: 12/730,896

(22) Filed: Mar. 24, 2010

Related U.S. Application Data
(60) Provisional application No. 61/162,907, filed on Mar. 24, 2009.

(51) Int. Cl. G06F 21/00; G06F 13/00; G06F 15/173; G06F 3/00

(52) U.S. Cl. 726/25; 710/316; 709/225; 710/47; 710/18

(57) ABSTRACT

An apparatus, system, and method for controlling access to a network. A device controls communication between a computer and the network. The device includes an integrated circuit receiving signals from one or more peripheral devices and transmitting the received signals to the computer, a first data connection connecting the computer to the device, and a second data connection connecting the apparatus to a network. The device also includes a switch connecting the first and second data connections and permitting the computer to access the network when in a first state and disconnecting the first and second data connections when in a second state. The device further includes a timer determining the time period since the last transmission of signals from the one or more peripheral devices, and when the time period since the last transmission of signals exceeds a predetermined time period the integrated circuit causes the switch to change from the first state to the second state.

### FIELD OF THE INVENTION

The present invention relates to methods and devices for preventing unauthorized access to computer networks. More particularly, the present invention is directed to limiting the time available for exploiting unauthorized access of a computer on a network via a PS/2 ported device.

### BACKGROUND

In order to exploit a computer network system, an adversary requires three things: time, some vulnerability, and a way (vector) of exploiting that vulnerability. If it is assumed that all systems have vulnerabilities, then it is reasonable to assert that the longer a computer is attached to a network the greater the chance that it can be compromised. Thus the most valuable resource computer network operators unwittingly provide to electronic adversaries is time.

Nonetheless, currently most attention is directed at vulnerability prevention, and after a network node is compromised, management and remediation. But most of the current vulnerability prevention technologies are ineffective and are continually overcome by events, new technology, and the adversary's techniques. For example, in the case of a compromised computer operating on a network, a common approach used by adversaries is to install a nearly undetectable backdoor software application called a rootkit. The rootkit provides access to the network via the computer even after the original vulnerability has been detected and patched. Indeed, some of these backdoors have been found to survive actions including reinstallation of the computer operating system (See e.g., Reversing and exploiting an Apple firmware update, K. Chen (2009)).

Additionally, by an attackers placement of the malware, rootkit, or a virtual machine in a lower layer of the system than the security systems are operating (See e.g., Sub Virt Implementing malware with virtual machines, S. King et al. (2009)), a network administrator taking of active steps to neutralize an attack and closing the window to future attacks cannot be confident that such actions have been successful. Even further, it has been found that in some instances the computer manufacturers themselves, with no perceived malicious intent, and with some reasonable justification (anti-theft technologies) have themselves installed within some machines access points. These manufacturer installed access points act as a rootkit allowing complete control of the computer. More importantly, these access points must by their intended function be very persistent in order to survive wiping of the entire system as is often the case when a computer is stolen. (Deactivate the Rootkit: Attacks on NIOS anti-theft technologies, A. Ortega et al. (2009)). As reported by Ortega, these anti-theft features can be, and have been, readily exploited because the manufacturer installed backdoors that do not include strong authentication requirements.

The stark reality is that most machines/systems/networks have already been compromised. And while there are good reasons for continued focus on vulnerability prevention and management, these will continue to provide only limited results. Indeed, these are ineffective solutions, with each new patch being circumvented by the next compromise technique.

In light of these difficulties a new approach has been contemplated wherein the focus shifts to the temporal aspects of an attack and not prevention. The present invention is directed to such approach.

### SUMMARY OF THE INVENTION

One aspect of the present invention is directed to reducing the window of time that an attacker can i) conduct a network attack and ii) exploit a system that has already been compromised by limiting the transmission of network data to only the time period the keyboard or mouse produces physical Input/Output signals (I/O signals). Said another way, present invention dramatically limits the time that any one computer or node of the network is able to “talk” on that network, preferably to the period of time the user is actually using the computer.

The present invention relates to an apparatus for controlling access to a network. The apparatus includes an integrated circuit receiving signals from one or more peripheral devices and transmitting the received signals a computer, a first data connection for connecting a computer to the apparatus, a second data connection for connecting the apparatus to the network, and a switch connecting the first and second data connections and permitting the computer to access the network when in a first state and disconnecting the first and second data connections when in a second state. The apparatus also includes a timer that determines the time period since the last transmission of signals from the one or more peripheral devices. When the time period since the last transmission of signals exceeds a predetermined time period the integrated circuit causes the relay to change from the first state to the second state.

The peripheral devices may be a keyboard, a mouse, and may be connected to the apparatus via a PS/2 connector. In one aspect of the invention the integrated circuit determines whether the signal originates from the computer or the one or more peripheral devices. In a further aspect of the invention, upon receiving a signal input via the one or more peripheral device the integrated circuit causes the switch to change from the second state to the first state. Further, upon the switch entering the first state the timer is reset to 0.

In another embodiment, the signals received by the integrated circuit are user initiated input signals generated upon the depression of a key on a keyboard or the movement of a mouse. Still further, a second timer may be implemented, the second timer determines whether a second time period is less than a poll delay value associated with the one or more peripheral devices, and when the second time period is less than the poll delay value associated with the one or more peripheral device, the integrated circuit causes the switch to change from the second state to the first state. Further still, the apparatus may be located on a network interface card (NIC).

Another aspect of the present invention is a method of controlling access to a network. The method includes the steps of receiving at an integrated circuit signals from one or more peripheral devices and transmitting the received signals to a computer, connecting via a switch first and second data connections when said switch is in a first position, and disconnecting via the switch the first and second data connections when the switch is in a second position. The method also includes a step of counting a time period since the last transmission of signals from the one or more peripheral devices, and when the time period since the last transmission of signals exceeds a predetermined time period the integrated circuit causes the relay to change from the first position to the second position.

In another aspect of the invention the connecting step enables a computer connected to the first connector to talk on a network connected to the second connector. Further, the integrated circuit can perform a step of determining whether the signal originates from the computer or the one or more peripheral devices, and a step of resetting the timer to 0 upon the switch changing from the second to the first position.

In another aspect of the invention, the integrated circuit can perform steps of receiving a signal input via the one or more peripheral devices, and causing the switch to change from the second position to the first position. The signals received by the integrated circuit may be user initiated input signals generated upon the depression of a key on a keyboard or the movement of a mouse.

Still a further aspect of the invention includes steps of counting a second time period and determining whether a second time period is less than a poll delay value associated with the peripheral device, and causing the switch to change from the second position to the first position when the second time period is less than the poll delay value associated with the peripheral device.

Yet a further embodiment of the present invention is a system including a computer and an apparatus for controlling communication between the computer and the network. The apparatus includes an integrated circuit receiving signals from one or more peripheral devices and transmitting the received signals to the computer, a first data connection for connecting the computer to the apparatus, a second data connection for connecting the apparatus to a network, and a switch connecting the first and second data connections and permitting the computer to access the network when in a first state and disconnecting the first and second data connections when in a second state. The system also includes a timer determining the time period since the last transmission of signals from the one or more peripheral devices, and when the time period since the last transmission of signals exceeds a predetermined time period the integrated circuit causes the switch to change from the first state to the second state.

Another aspect of the present invention is directed to a method of controlling access to a computer network. The method includes steps of monitoring signals carried by a bus connected between one or more peripheral devices and a computer, counting a time period starting from a time of sensing a signal sent from the one or more peripheral devices, and disconnecting the computer from a network when the time period exceeds a predetermined time period. The connecting step enables the computer connected to the first connector to talk on a network connected to the second connector. Another aspect of this invention involves monitoring signals originating from the computer; and ignoring a signal sent from the one or more peripheral devices for a predetermined time after detecting a signal originating from the computer. This method may also involve a steps of resetting the counting to 0 upon sensing a signal sent from the one or more peripheral devices and connecting the computer to the network upon sensing a signal sent from the one or more peripheral devices.

According to a further aspect of this invention, the monitored signals are user-initiated input signals generated upon the depression of a key on a keyboard or the movement of a mouse. And the method includes steps of counting a second time period and determining whether the second time period is less than a poll delay value associated with the one or more peripheral devices, and connecting the computer to the network when the second time period is less than the poll delay value associated with the one or more peripheral devices.

Other features and advantages of the invention will appear from the following description in which the preferred embodiments have been set forth in detail, in conjunction with the accompanying drawings.

### BRIEF DESCRIPTION OF THE DRAWINGS

FIG. 1 is a schematic of a system according to a first aspect of the present invention;

FIG. 2 is a flow chart showing a second aspect of the present invention;

FIG. 3 is a flow chart showing a third aspect of the present invention.

FIG. 4 is a flow chart showing a fourth aspect of the present invention.

FIG. 5 is a flow chart showing a fifth aspect of the present invention.

FIG. 6 is a flow chart showing a sixth aspect of the present invention.

FIG. 7 is a flow chart showing a seventh aspect of the present invention.

FIG. 8 is a flow chart showing an eighth aspect of the present invention.

FIG. 9 is a prior art rendering of a PS/2 connector.

### DETAILED DESCRIPTION OF THE PREFERRED EMBODIMENTS

Heretofore, little attention has been spent focusing on the time aspects of network/system security. What is required is a method and apparatus that reshapes the time window that an adversary has to act against vulnerabilities; and assuming a system is already compromised, reshape the period of time the adversary has to exploit the compromised system/network, but at the same time not compromise the intended user's ability to utilize the network.

One metric of “actual use” is the time when a physical I/O signal is being generated by peripheral device, e.g., when actual signals are generated by the depression of keys or the movement of a mouse by a user physically sitting at a computer terminal. According to the present invention, in the absence of I/O signals from the keyboard or mouse (or any other peripheral device), the computer is disconnected from the network so that an adversary cannot use another computer on the network to gain unauthorized access to the computer. Thus, the present invention only allows a computer to communicate with the network when an intended user is physically at the computer generating physical I/O signals via the mouse or keyboard.

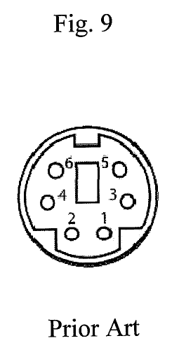

As noted above, the present invention is particularly directed towards monitoring a mouse or keyboard connected to a computer via a PS/2 connector. A PS/2 connector is used for connecting keyboards and mice to a PC-compatible computer system. Its name comes from the IBM Personal System/2 series of personal computers, with which it was introduced in 1987. A female PS/2 connector is shown in FIG. 9.

By monitoring the I/O signals originating from a keyboard or a mouse and by severing the connection between the computer and the network after a predetermined period of inactivity, the adversary or the software produced by the adversary is denied the necessary time to access the target computer and gather desired information. Further, depending upon the type of malware or rootkit the computer is infected with, the adversary who caused the infection is prevented from being able to takeover the computer to access the network via remote operation of that computer.

In a preferred embodiment, the security device is implemented at the hardware-level and does not rely on any software that runs on the computer's operating system. Implementing the security system at the hardware-level makes it more difficult for an adversary to exploit the security aspects of the invention via software measures.

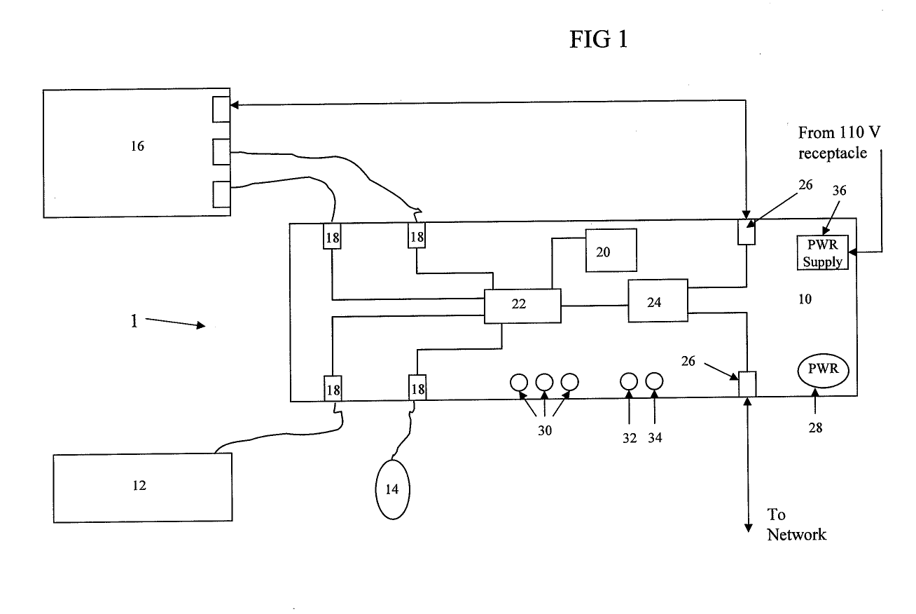

FIG. 1 depicts one aspect of the present invention in which system 1 includes a stand-alone security device 10 that can sever the connection between a computer 16 and a network upon sensing a failure to receive physical I/O signals from the keyboard 12 or mouse 14 for some predetermined period. To limit the time available to any malware or rootkit, a switch or relay 24 is employed to limit the connection to the network only to those times during which physical I/O signals are being transmitted from the keyboard 12 or mouse 14 to the computer 16. In one configuration, as shown, the security device 10 is a physical component separate from the computer to which the keyboard 12 and mouse 14 are connected. One of skill in the art will appreciate that this system could be incorporated onto a computer's network interface card (NIC) and made part of the computer 16.

The security device 10 includes inputs and output ports 18 that are connectable to the computer 16 and to the mouse 14 and keyboard 12 (and other peripheral devices not shown). The security device 10 allows the I/O signals sent from the peripheral devices 12, 14 to reach the computer 16 and I/O signals sent from the computer 16 to reach the peripheral devices 12, 14. The I/O signals transmitted from the mouse 14, keyboard 12, and computer 16 are received by the microcontroller 22 in the security device 10, and passed along to the intended device. The microcontroller 22 may be, for example, a MSP430F2013 or MSP430G2013 integrated circuit manufactured by Texas Instruments. A JTAG port (not shown) may also be incorporated into the security device for the programming of the microcontroller 22. The functionality of the microcontroller 22 may be hardcoded such that the microcontroller 22 installed by the manufacturer cannot be re-flashed or altered by an attacker, thus preventing circumvention of the security device 10. This may, for example, be accomplished by causing a fuse in the JTAG port to blow after the manufacturer installs the necessary software or firmware in the security device 10.

The network connections 26 connect the computer 16 to the security device 10 (e.g., via a standard RJ45 connection) and they connect the security device 10 to the network. The security device 10 also includes a third integrated circuit that is used to regulate the voltage used to power the security device shown in FIG. 1 as power supply 36. For example, the power supply 36 may be a TPS77633 constant-voltage power supply manufactured by Texas Instruments. The TPS77633 controls the voltage of the security device 10 in one embodiment at a constant 3.3 volts.

Elements 32 and 34 are light emitting diodes (LEDs). Element 32 is the active LED and when illuminated indicates that the switch or relay 24 is closed and that the computer is actively connected to the network. Element 34 is the inactive LED and when illuminated indicates that the computer is no longer connected to the network and that the relay is open. These LEDs provide a visual indicator of the status of the security device 10 and the relative security of the computer at all times.

Incorporated within the security device 10 is a relay 24 that opens when the microcontroller 22 senses the absence of signals sent from one or more peripheral devices for a predetermined period, which may be set in the timer 20. When the relay 24 opens, the two network connections 26 are disconnected from each other, isolating the computer 16 from the network. Though shown as a separate component, one of skill in the art will appreciate that the timer 20 may be embodied as software executed by the microcontroller 22. The microcontroller 22, in addition to passing I/O signals to and from the mouse 14 and keyboard 12, also senses whether physical I/O signals from the keyboard 12 or the mouse 14 are being received at the microcontroller 22. Whenever a physical I/O signal is received, the timer 20 resets to 0 and restarts counting time.

Upon the expiration of a certain time period, the timer 20 causes the microcontroller 22 to send a signal to the switch or relay 24 causing the switch or relay 24 to open and sever the connection between the computer 16 and the network. In some embodiments, the microcontroller 22 may be configured to continually transmit a signal to the relay 24 to keep it closed. In these embodiments, upon the expiration of a certain time period, the timer 20 causes the microcontroller 22 to discontinue transmitting a signal to the relay 24 causing the relay 24 to open. The switch or relay 24 may, for example, be a TS3L100PW integrated circuit manufactured by Texas Instruments.

To limit the difficulties for the user, upon the striking of key on the keyboard 12 or using of the mouse 14, the reception of verified physical I/O signals at the microcontroller 22 causes the relay 24 to again close, reestablishing the connection to the network and resetting the timer 20. In a preferred embodiment this re-connection of the network to the computer 16 will appear seamless such that the user could not detect it.

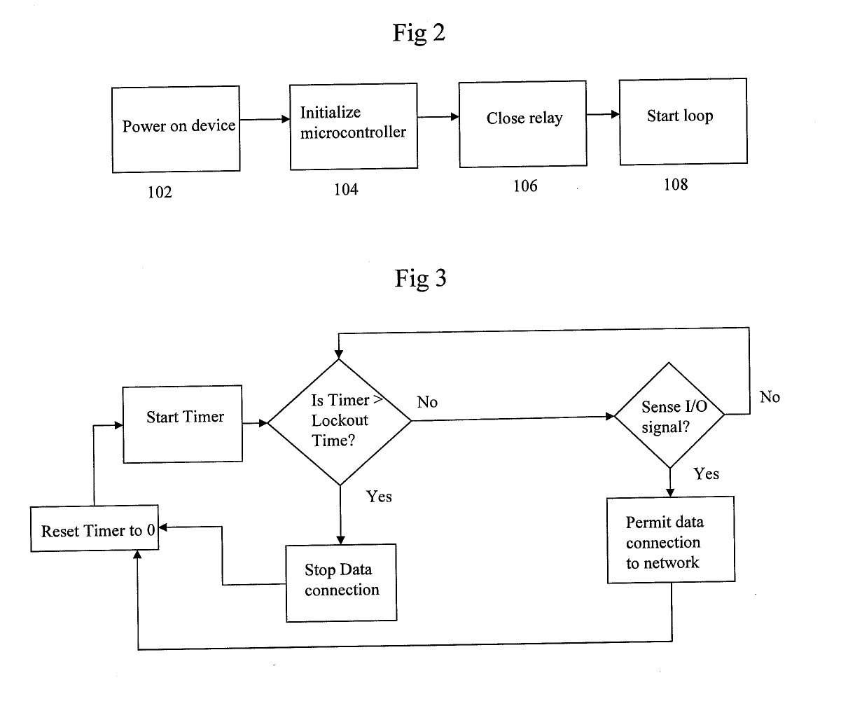

FIG. 2 is a flow diagram depicting operation of certain aspects of the microcontroller 22 within the security device 10. Following depression of the power on button 28 of the security device 10 in step 102, the microcontroller 22 is initialized in step 104. Initialization of the microcontroller 22 may include reading out of memory instructions that tell the microcontroller 22 which of its pins are inputs and which are outputs. The input pins include pins that receive keyboard and mouse I/O, keyboard and mouse clock signals, and/or a timer signal. The output pins include pins through which various LEDs are turned on with a voltage signal. The LEDs include active LED 32 and inactive LED 34, as well as level indicator LEDs 30 which visually depict, for example, the duration of the lockout time set by the user.

The switch or relay 24 connections may also be configured as outputs of the microcontroller 22, thus allowing the microcontroller 22 to control the opening and closing of the switch or relay 24. Certain variables are also read out of memory, for example, an initial lockout value, that is, a value representing the length of time the switch or relay 24 may remain closed without the microcontroller 22 receiving further I/O signals from the keyboard 12 or mouse 14, after which the switch or relay 24 is opened and the connection to the network is severed. Other variables may include an initial timer value.

Following initialization, software instructions cause the microcontroller 22 to close the relay 24, at step 106. Having closed the switch or relay 24, a connection between the computer 16 and the network is established, and the control loop, as shown for example in FIG. 3, is begun at step 108.

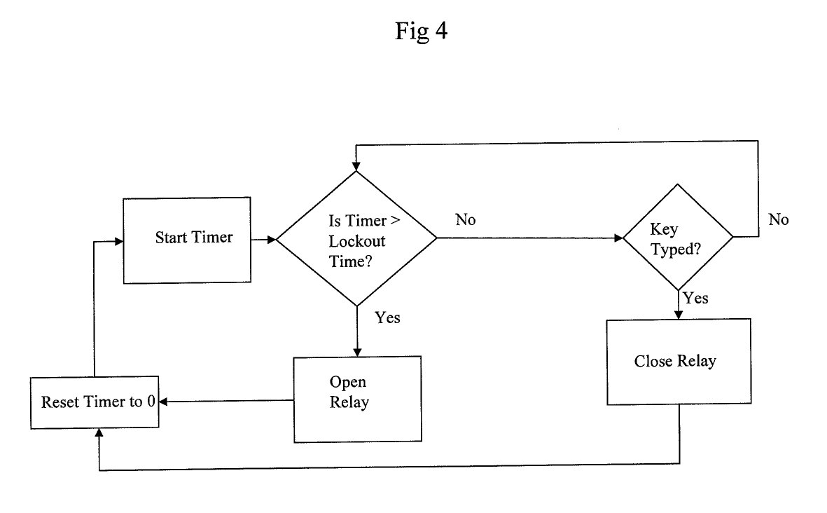

The control loop, as shown in FIGS. 3 and 4, may be a software implemented control loop through which the security device monitors the physical I/O signals received from the user via the keyboard 12 and the mouse 14 to ensure that the computer 16 is being physically operated. As noted above, one of the variables that may be established during initialization of the microcontroller 22 is the lockout timer. The lockout time is the duration of time that may transpire between key strokes or movement of the mouse and still maintain a connection between the computer 16 and the network. To begin the control loop, the timer is started. Once started, the first inquiry is whether the timer value exceeds the set lockout time. If the answer is yes, then a signal is sent from the microcontroller 22 to the switch or relay 24 causing the relay to open and thus severing the connection between the computer 16 and the network. This also causes the timer to be reset to 0, and restarts the running of the timer.

If the answer to the first inquiry is no, then a subsequent inquiry is made to determine whether there has been any physical I/O signal sent from the keyboard 12 or mouse 14 to the computer through the security device 10. If the answer to this second inquiry is no, then the first inquiry regarding whether the timer value exceeds the lockout time is repeated. This loop continues until either the timer value exceeds the lockout time, in which case the network connection is severed, or the microcontroller senses the transmission of a physical I/O signal from the key board 12 or mouse 14. When this physical I/O signal is sensed, the microcontroller 22 causes the relay 24 to close and the data connection between the computer and the network is permitted.

In the event the network connection is already established and the relay 24 is already closed, then the network connection is simply maintained. Following either the permitting of the network connection or maintaining the network connection, the timer is reset to 0 and the steps described above are repeated in a continuous fashion either permitting or stopping the data connection between the computer 16 and the network depending on whether the security device senses an I/O signal.

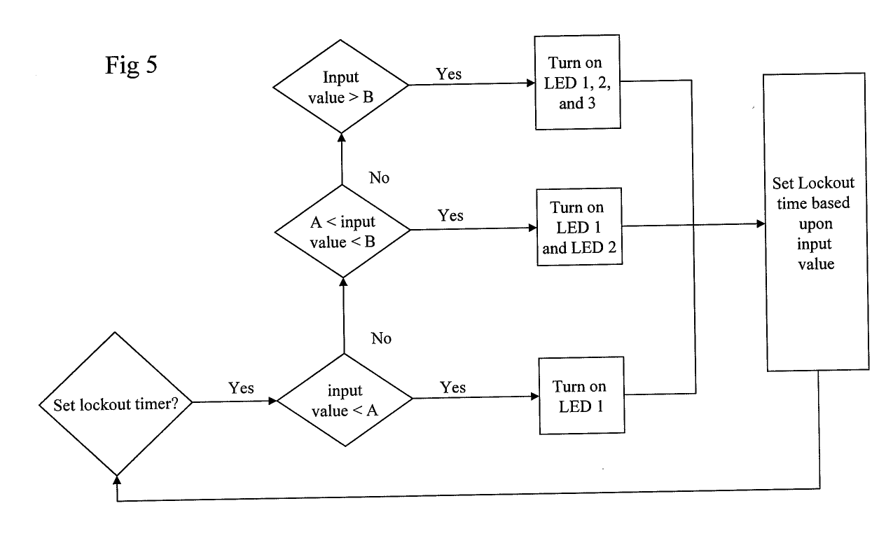

Another aspect of the present invention is the setting of the lockout time by the user or manufacturer, as shown in FIG. 5. Again, this implementation may be performed using software that is executed by the microcontroller 22. In FIG. 1, a power button 28 is shown. In one embodiment of the present invention, a user, after powering on the security device 10, may press and hold the power button 28. After sensing that the power button 28 has been depressed for greater than a predetermined duration of time, for example 3 seconds, the microcontroller 22 enters a set lockout time mode. Upon sensing that the user wishes to enter the set lockout time mode, and with the user still holding the power button 28, the microcontroller further senses the length of time the power button 28 is depressed.

If the power button 28 is depressed for less than a time A, for example, 5 seconds, then only a first LED 30 is switched on. If the power button 28 is held for a duration between times A and B, for example, between 5 and 15 seconds, then the first and a second LEDs 30 are switched on. And if the length of time a user holds the power on button exceeds a duration B, for example, longer than 15 seconds, then LEDs 1-3 are all switched on. Following depression of the power button 28 for any period of time and the switching on of one or more of the LEDs, then the microcontroller sets the lockout time based upon the length of time the power button 28 was depressed in connection with a pre-set correlation value. For example, holding the power on button for between 5 and 15 seconds may correlate to a lockout time of 30 seconds. One of skill in the art would readily understand that other times and correlations would be possible and the above is merely an example thereof.

The LEDs provide a visual indicator to the user of the length of the lockout time, that is, the length of time between either keystrokes or movement of the mouse to create physical I/O signal without severing the connection between the computer 16 and the network. As will be appreciated, the shorter the duration of the lockout time the greater the security for the computer.

Depending upon the application, the manufacturer can set a series of ranges that the user can utilize for the lockout time. These ranges could be as brief as 5, 10, 15, and 30 seconds, or as long as 5, 10, 15, and 30 minutes, depending upon the desires of the user, the sensitivity of the network and computer content, and other factors. One of skill in the art will recognize that other times both greater and smaller than those described above could be implemented on the device for the lockout time, and the only limitations are the switching speed of the microcontroller and the relay and the time required to perform the routines described herein.

Another use of the LEDs 30 is as an indicator of time remaining until the relay 24 will be opened or the time elapsed since the last use of a peripheral device. Once the lockout time has been set, either using the default value from an initialization step or as set by the user, and once the security device 10 has exited from the set lockout time mode, all of the LEDs can be illuminated. As the timer counts, during set intervals within the total lockout time, one of the LEDs can be extinguished. For example, if the lockout time is set by the user at 30 minutes, each LED can represent a 10-minute interval within the 30-minute lockout time interval. Thus, after the last I/O signal from the keyboard 12 or mouse 14 is received by the microcontroller and the timer is reset to 0, all of the LEDs are turned on. After 10 minutes, one of the LEDs is extinguished. After 20 minutes, a second LED is extinguished. After 25 minutes, the last LED is extinguished, and, after 30 minutes, the active LED 32 is extinguished and the inactive LED 34 is turned on. Other embodiments where, for example, the last remaining LED flashes during the last 5 minutes of the lockout time interval to get the user's attention are also possible and considered within the scope of the present invention.

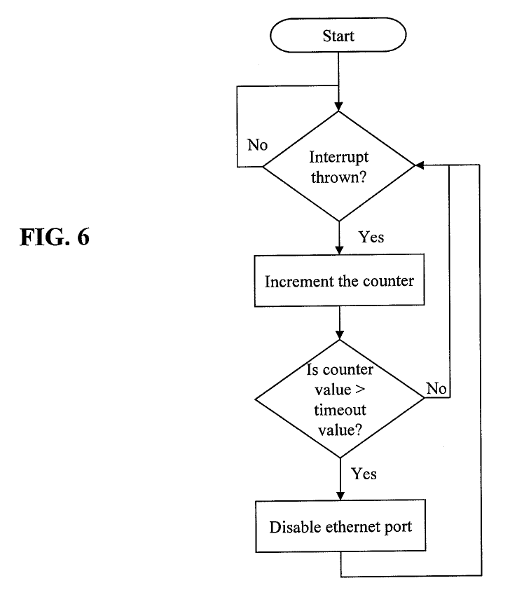

FIG. 6 is a flow diagram of an interrupt service routine in accordance with a further embodiment of the present invention. When an interrupt is thrown, an internal counter or timer is incremented. Then, it is determined whether the counter value is greater than a preset lockout time. If the counter value is greater than the lockout time, then the connection between the computer 16 and the network is severed and the interrupt service routine ends. If the counter value is not greater than the timeout value, then the interrupt service routine ends. The interrupt service routine may be called and executed at periodic intervals determined by a timer internal to the security device.

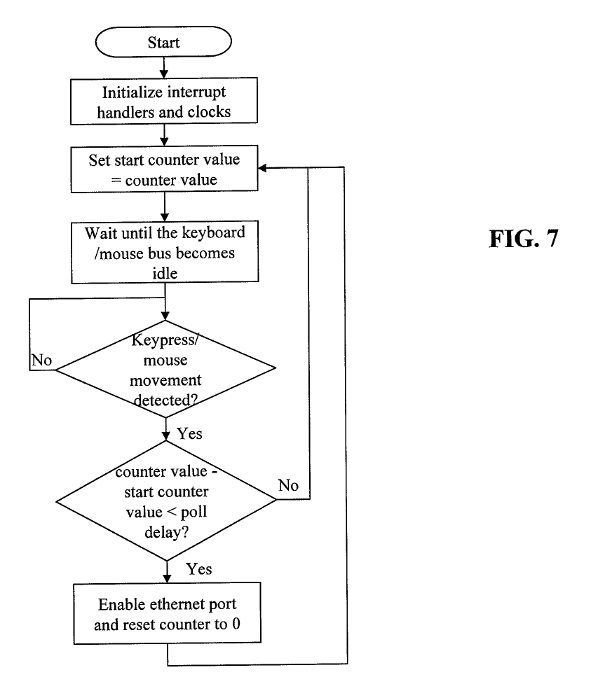

FIG. 7 is a flow diagram of a software routine that is executed while the interrupt service routine (shown in FIG. 6) is repeatedly called. After the software routine starts, the interrupt handlers and clocks are initialized. Then, in the software routine the start counter value or timer is set equal to the counter value or timer that is incremented in the interrupt service routine (FIG. 6). The start counter value marks the beginning of the next step, in which the processor waits until the peripheral (keyboard and/or mouse) bus becomes idle. This ensures that any activity on the peripheral bus that is not an actual key strike or mouse movement is not incorrectly detected as a key strike or mouse movement. The delay until an idle state of communications on the bus is detected also prevents the false interpretation of a signal originating from the computer side of the security device 10 (or a signal sent from the peripheral device in response to a signal originating from the computer) from being incorrectly interpreted as a I/O signal relating to actual use of the peripheral device.

In the next step, the microcontroller 22 determines whether a key strike or movement of the mouse is detected. If a key strike or movement of the mouse is detected, the microcontroller 22 executes software instructions that determine whether the difference between the counter value and the start counter value is less than a poll delay. The poll delay is the time between poll signals that the keyboard and mouse transmit to the computer when the keyboard and mouse are in an idle state (e.g., when the keyboard and mouse are not actually being used). The poll signals may also originate from the computer 16.

In some embodiments, the poll delay value in the memory of the security device 10 may be set to a value less than the actual poll delay (e.g., the poll delay value may be set to 0.75 seconds when the actual poll delay is 1 second). This ensures that the poll signal is not improperly detected as mouse movement or a key strike. If the difference between the counter value and the start counter value is less than the poll delay value, then the connection between the computer 16 and the network is enabled and the counter is reset to zero. Otherwise, the step in which the start counter value is set equal to the counter value and the subsequent steps are repeated. By having the difference of the counter value and the start counter being less than the poll delay value, and incorporating the delay to wait for an idle state of the bus, the security device 10 can verify that the received signal is the result of an actual key strike or mouse movement.

The bus between the keyboard or mouse and the host machine may carry digital signals according to the PS/2 protocol, which is a bidirectional, open-collector, synchronous serial protocol. The bus includes a clock line and a data line. These lines enter an idle state when they are pulled up to high voltage (e.g., 5 volts).

The computer 16 includes a controller that can transmit messages or packets to a peripheral device after executing a request to send sequence of instructions (i.e., pulling the clock line of the peripheral device to a low voltage for a predetermined amount of time (e.g., 100 microseconds), pulling the data line of the peripheral device to low voltage, and then releasing the clock line of the peripheral device to the high voltage). When the peripheral device receives a packet from the controller of the computer 16, it responds by sending a packet to the controller. An adversary could remotely access the controller and attempt to imitate an I/O signal relating to actual use of a peripheral device by sending a data packet to the peripheral device from the computer's controller to cause the keyboard to send a data packet (which is a fake I/O signal relating to actual use of a peripheral) back to the computer.

Typically, however, controllers of the computer 16 do not have sufficiently low level access to allow a user to transmit data packets to the keyboard and mouse. For example, for computers on which the controller is masked-ROM programmed, a user cannot access the controller to transmit data packets to the peripheral device. Thus, the controller itself is not usually considered a vector for attack.

But to prevent such an attack, in yet a further embodiment, the security device 10 may look at the data that is transmitted on the bus between the peripheral device and the computer to determine whether there has been actual use of the peripheral device (e.g., key strike on a keyboard). In this way, the security device 10 of the present invention can distinguish between an I/O signal relating to actual use of a peripheral and a response to a signal sent from the computer 16.

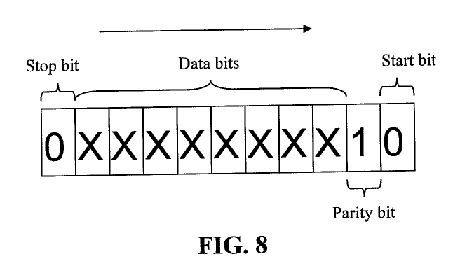

According to one aspect of the present invention, to prevent the interpretation of a response of the peripheral device to a signal from the computer from being considered a key strike or mouse movement, the security device 10 monitors the bits of the data packets transmitted by the keyboard or mouse. As shown in FIG. 8, the data packets include eleven bits: a start bit, a parity bit, eight data bits and a stop bit. In some embodiments, the security device 10 looks at the start bit of the data packet to determine whether the data packet relates to an actual use of the peripheral device (e.g., a key press on a keyboard) or merely a response to a computer's request to transmit a signal from the computer 16. For example, a start bit equal to zero may indicate a key press whereas a start bit equal to one may indicate a keyboard's response to a computer's request to transmit a signal to the keyboard. Here again, the security device 10 may wait for a predetermined amount of time (e.g., 1/16^{th} of a second) before monitoring the start bit of the data packets sent from the peripheral device to prevent the interpretation of a portion of a data byte or other signal from being falsely interpreted as a start bit.

In yet a further embodiment, the security device 10 may monitor for signals sent from the computer 16 and ignore any signal sent from the peripheral device for a predetermined time period after sensing a signal sent from the computer 16. In this way, the security device 10 will not incorrectly interpret a response (i.e., an acknowledgement message) to a signal sent from the computer 16 as a key press or movement of the mouse. The security device 10 may sense a signal sent from the computer 16 by detecting a voltage across a resister placed in line with the ports 18 of the security device 10 that connect directly to the computer.

One of skill in the art will readily appreciate that modifications may be made to the disclosed embodiments without departing from the subject and spirit of the invention as defined by the following claims.

We claim:

1. An apparatus for controlling access to a network comprising:
an integrated circuit receiving signals from one or more peripheral devices and transmitting the received signals to a computer;
a first data connection for connecting a computer to the apparatus;
a second data connection for connecting the apparatus to a network;
a switch connecting the first and second data connections and permitting the computer to access the network when in a first state and disconnecting the first and second data connections when in a second state; and
a timer determining a time period since the last transmission of signals from the one or more peripheral devices, wherein when the time period since the last transmission of signals exceeds a predetermined time period the integrated circuit causes the switch to change from the first state to the second state.

2. The apparatus of claim 1, wherein the one or more peripheral devices is a keyboard.

3. The apparatus of claim 1, wherein the one or more peripheral devices is a mouse.

4. The apparatus of claim 1, wherein the one or more peripheral devices is connected to the apparatus via a PS/2 connector.

5. The apparatus of claim 1 wherein the integrated circuit determines whether the signal originates from the computer or the one or more peripheral devices.

6. The apparatus of claim 1, wherein upon receiving a signal input via the one or more peripheral device the integrated circuit causes the switch to change from the second state to the first state.

7. The apparatus of claim 1, wherein upon the switch entering the first state the timer is reset to 0.

8. The apparatus of claim 1, wherein the signals received by the integrated circuit are user-initiated input signals generated upon the depression of a key on a keyboard or the movement of a mouse.

9. The apparatus of claim 8 further comprising a second timer, said second timer determining whether a second time period is less than a poll delay value associated with the peripheral device, wherein when the second time period is less than the poll delay value associated with the peripheral device, the integrated circuit causes the switch to change from the second state to the first state.

10. The apparatus of claim 9, wherein the apparatus is located on a network interface card (NIC).

11. A method of controlling access to a network comprising the step of:
receiving at an integrated circuit signals from one or more peripheral devices and transmitting the received signals a computer;
connecting via a switch first and second data connections when said switch is in a first position;
disconnecting via the switch the first and second data connections when the switch is in a second position; and
counting a time period since the last transmission of signals from the one or more peripheral devices, wherein when the time period since the last transmission of signals exceeds a predetermined time period the integrated circuit causes the switch to change from the first position to the second position.

12. The method of claim 11, wherein the connecting step enables a computer connected to the first connector to talk on a network connected to the second connector.

13. The method of claim 11, wherein the one or more peripheral devices is a keyboard.

14. The method of claim 11, wherein the one or more peripheral devices is a mouse.

15. The method of claim 11, wherein the one or more peripheral devices is connected via a PS/2 connector.

16. The method of claim 11, wherein the integrated circuit performs a step of determining whether the signal originates from the computer or the one or more peripheral devices and ignoring a signal send from the one or more peripheral devices for a predetermined time after detecting a signal originating from the computer.

17. The method of claim 11, further comprising a step or resetting a counter to 0 upon the switch changing from the second to the first position.

18. The method of claim 11, further comprising the steps of the integrated circuit:
receiving a signal input via the one or more peripheral devices; and
causing the switch to change from the second position to the first position.

19. The method of claim 18, wherein the signals received by the integrated circuit are user-initiated input signals generated upon the depression of a key on a keyboard or the movement of a mouse.

20. The method of claim 19 further comprising the steps of:
counting a second time period and determining whether a second time period is less than a poll delay value associated with the peripheral device.

21. The method of claim 20 further comprising a step of:
causing the switch to change from the second position to the first position when the second time period is less than the poll delay value associated with the one or more peripheral devices.

22. A system comprising:
a computer,
an apparatus for controlling communication between the computer and a computer network, the apparatus including,
an integrated circuit receiving signals from one or more peripheral devices and transmitting the received signals to the computer;
a first data connection for connecting the computer to the apparatus;
a second data connection for connecting the apparatus to the computer network;
a switch connecting the first and second data connections and permitting the computer to access the computer network when in a first state and disconnecting the first and second data connections when in a second state; and
a timer determining the time period since the last transmission of signals from the one or more peripheral devices, wherein when the time period since the last transmission of signals exceeds a predetermined time period the integrated circuit causes the switch to change from the first state to the second state.

23. A method of controlling access to a computer network, comprising:
monitoring signals carried by a bus connected between one or more peripheral devices and a computer;
counting a time period starting from a time of sensing a signal sent from the one or more peripheral devices; and
disconnecting the computer from a network when the time period exceeds a predetermined time period.

24. The method of claim 23, wherein the connecting step enables the computer connected to the first connector to talk on a network connected to the second connector.

25. The method of claim 23, further comprising:
monitoring signals originating from the computer; and
ignoring a signal sent from the one or more peripheral devices for a predetermined time after detecting a signal originating from the computer.

26. The method of claim 23, further comprising:
resetting the counting to 0 upon sensing a signal sent from the one or more peripheral devices.

27. The method of claim 23, further comprising:
connecting the computer to the network upon sensing a signal sent from the one or more peripheral devices.

28. The method of claim 27, wherein the monitored signals are user-initiated input signals generated upon the depression of a key on a keyboard or the movement of a mouse.

29. The method of claim 28, further comprising:
counting a second time period and determining whether the second time period is less than a poll delay value associated with the one or more peripheral devices.

30. The method of claim 29, further comprising:
connecting the computer to the network when the second time period is less than the poll delay value associated with the one or more peripheral devices.
